(19) United States
(12) Patent Application Publication
(10) Pub. No.: US 2024/0367329 A1
(43) Pub. Date: Nov. 7, 2024

(54) GRIPPING HEAD, IN PARTICULAR FOR APPLYING A PATCH TO A SURFACE TO BE DRAPED

(71) Applicant: SAFRAN NACELLES, Gonfreville-L'ocher (FR)

(72) Inventors: Renaud Venture, Moissy Cramayel (FR); Benjamin Provost, Moissy Cramayel (FR); Clément Rolland, Moissy Cramayel (FR); Maxime Lebegue, Moissy Cramayel (FR)

(73) Assignee: SAFRAN NACELLES, Gonfreville-L'orcher (FR)

(21) Appl. No.: 18/287,169

(22) PCT Filed: May 10, 2022
(86) PCT No.: PCT/FR2022/050895

§ 371 Date: Oct. 16, 2023

(30) Foreign Application Priority Data
May 10, 2021 (FR) 2104937

(51) Int. Cl. B25J 15/06

(52) U.S. Cl. CPC B25J 15/0625

(57) ABSTRACT

A gripping head can be used for applying a patch to a surface to be draped. The gripping head for gripping a patch and applying the patch to a surface to be draped includes a suction chamber delimiting a suction sector and connected to a suction intake and a gripper connected to said suction chamber and comprising a piece of elastically deformable material configured to grip a patch under a gripping effect created in said suction chamber. The gripper includes selectively activatable gripping zones and the gripping head includes means for selectively activating the gripping zones.

The present invention relates to the gripping or handling of parts and in particular the gripping and depositing of patches on a support during the manufacturer of composite parts.

More particularly, the invention relates to a gripping head for gripping and depositing a patch on a support during the manufacturer of composite parts.

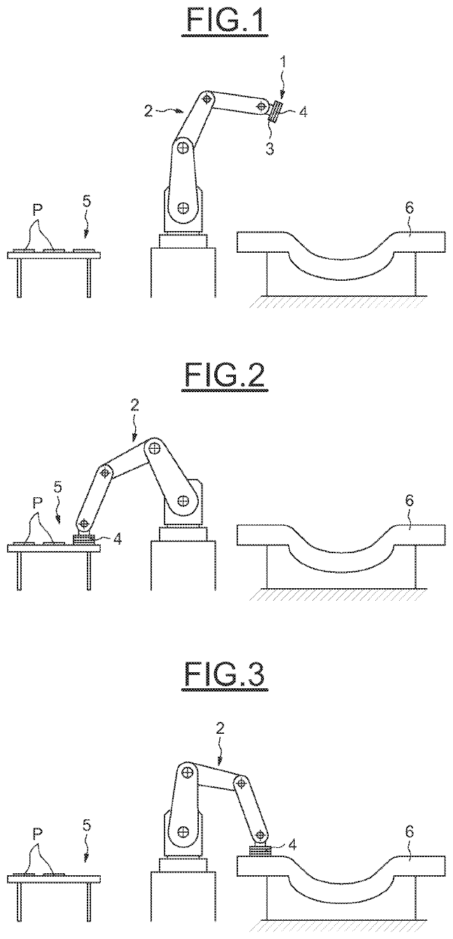

With reference to FIG. 1, a gripping head 1 of a so-called “pick and place” automatic draping machine conventionally comprises an effector mounted on a carrier 2 that for example consists of a robotic arm, or that is controlled by a digital control machine.

The effector generally includes a rigid support 3 that fixes at the end of the carrier of the machine and a piece of elastically deformable material 4 mounted on a rigid support and provided with through channels or cells, wherein a vacuum is created to grasp the patch by suction.

The draping machine is generally programmed to control the movement and the operation of the gripping head, so that, during a first step, illustrated in FIG. 2, it grasps a patch P on a provision device 5, for example, a supply table, a conveyor belt or a drawer system, so that, during a second step, illustrated in FIG. 3, the carrier moves the gripping head up to the support to be draped 6 and the patch is deposited on a target surface of the support and so that, during a third step, the carrier withdraws and the patch is detached from the gripping head 1.

During the application of the patch on the target surface, the carrier exerts a pressure by compacting the piece of deformable elastic material in such a way as to remove air, guarantee the shaping of the patch according to the shape of the target surface and obtain a sufficient adhesion of the patch so that it detaches from the gripping head during the withdrawal of the carrier.

The shape specificities of the supports to be draped may require particular motions of the carrier so that the entire surface of the patch is applied against the target surface.

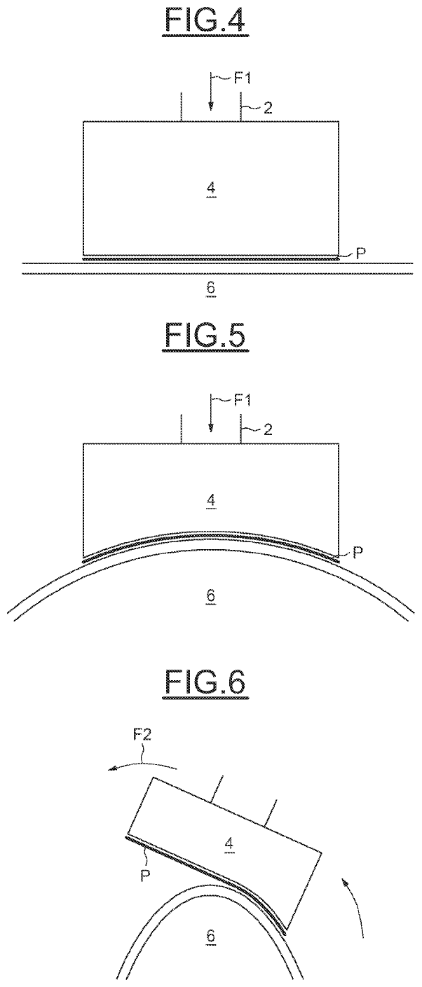

With reference to FIGS. 4 and 5, when the target surface is flat or has a convexity with a relatively large radius of curvature, the approach of the effector is carried out in a direction normal to the target surface (arrows F1).

With reference to FIGS. 6 to 8, when the target surface to be draped is convex with a relatively small radius of curvature, or when the surface to be draped has a chamfer, the gripping head must carry out a rotational motion about an axis parallel to the target surface in such a way as to develop the patch on the surface.

The effector is approached from the target surface in a direction normal to its target surface then is rotationally controlled to cause the application of the patch against the surface of the part (arrows F2).

The kinematic of the carrier must therefore be adapted depending on the shape specificities of the target surface. Additional constraints arise according to the nature of the material of the part to be draped, which may in particular be made of metal material, polymer, thermoplastic material, carbon, or glass, etc.

During the operation of the gripping head, the correct holding of the patch must be guaranteed throughout the entire phase of applying the patch to the target surface. Conversely, during the withdrawal of the carrier, the patch must easily detach from the piece of deformable material in order to remain applied to the target surface, without surface irregularity.

When the shape of the target surface is such that it requires moving the gripping head according to a motion comprising a rotational component, the suction of the patch may be cut off after the patch has been applied against a portion of the target surface, before the rotational motion of the head. In this case, the patch, which is no longer held by the gripping head, falls directly on the uncoated zone of the target surface, which is likely to result in wrinkles.

The suction may also be cut off at the end of the rotational motion. In this case, the patch is likely to remain applied against the piece of deformable material during the rotational motion, and therefore detach from the surface to which it was applied at the beginning of the rotational motion.

Therefore, the aim of the invention is to overcome these drawbacks and propose a gripping head for gripping a part guaranteeing the correct application of the part to a target surface, in particular when the target surface has shape specificities requiring a motion of the gripping head comprising a rotational component.

Therefore, the object of the invention, according to a first aspect, is a gripping head for gripping a part and depositing the part on a target surface, comprising a suction chamber delimiting at least one suction sector and connected to at least one suction intake and a piece of elastically deformable material configured to grip the part under a vacuum effect created by said suction chamber.

The piece of elastically deformable material includes selectively activatable gripping zones, the gripping head including means for selectively activating the gripping zones.

According to another feature, the suction chamber comprises a plurality of separate suction sectors each connected to a suction intake, the suction sectors being separated by sealed partitions.

In another embodiment, the suction chambers include a plurality of suction sectors separated by valves controlled during opening and closing to selectively place the suction sectors in communication.

According to yet another feature of the gripping head, the or each suction sector is connected to at least one overpressure intake.

In one embodiment, the piece of elastically deformable material includes an array of channels in communication with the suction chamber.

Each channel may be provided with a valve selectively controlled during opening and closing.

Advantageously, the gripping head includes an assembly of at least one element for measuring the application pressure of the gripping head on the target surface to servo-control the application pressure of the gripping head.

In one embodiment, the means for selectively activating the gripping zones include means for selectively activating the gripping zones depending on the pressure prevailing in the suction sectors.

It can also be envisaged that the means for selectively activating the gripping zones include means for selectively activating said suction sectors from control data of the suction head.

In this case, the means for selectively activating the gripping zones may include means for selectively activating the suction sectors depending on the position of the head or on the configuration of the part.

Another object of the invention, according to another aspect, is a machine for draping parts to be draped that includes a draping head such as defined above.

Other aims, features and advantages of the invention will appear upon reading the following description, given solely as a non-limiting example, and made with reference to the appended drawings wherein:

FIG. 1,

FIG. 2,

FIG. 3,

FIG. 4,

FIG. 5,

FIG. 6,

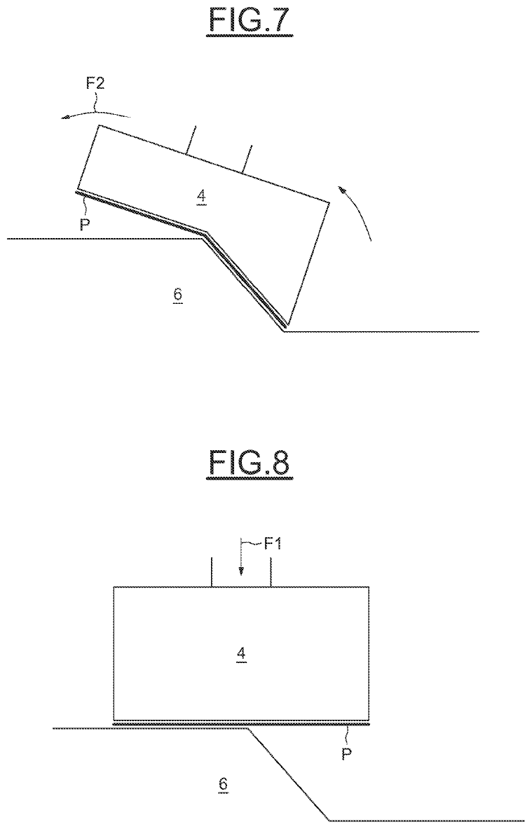

FIG. 7 and

FIG. 8 already mentioned, illustrate the kinematic of a draping head according to the prior art for various shapes of the target surface of a part to be draped;

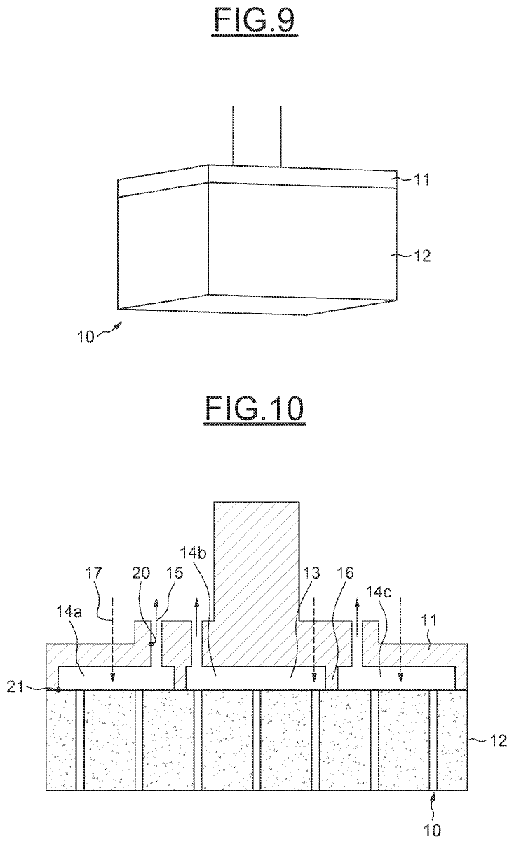

FIG. 9 is a schematic view of a gripping head in accordance with the invention;

FIG. 10 is a longitudinal sectional view of a first embodiment of the gripping head of FIG. 9;

FIG. 11 is a longitudinal sectional view of a second embodiment of a gripping head in accordance with the invention;

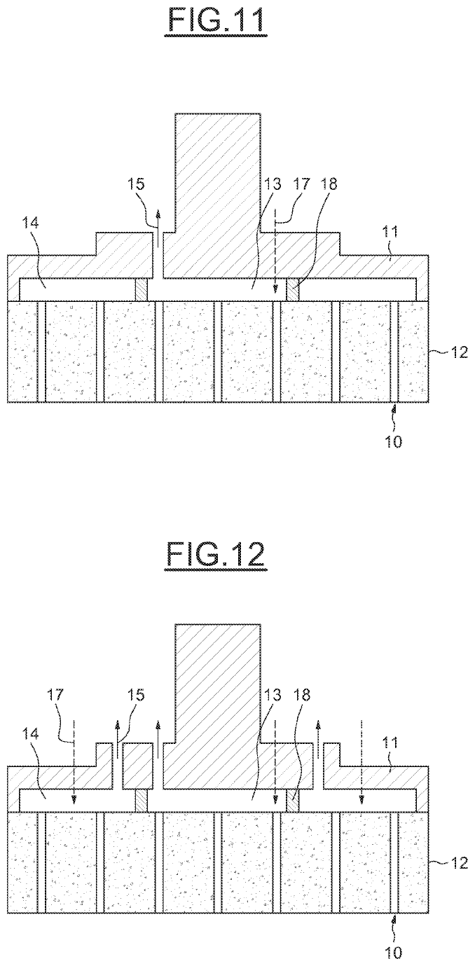

FIG. 12 is a longitudinal sectional view of a third embodiment of a gripping head in accordance with the invention; and

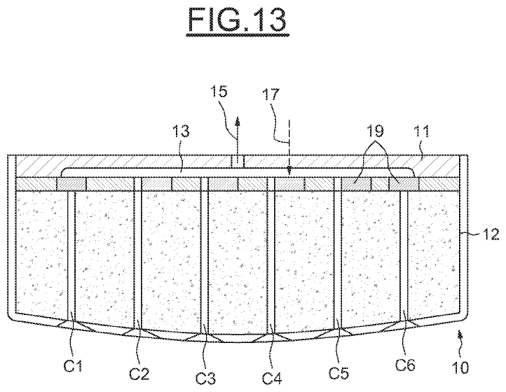

FIG. 13 illustrates a fourth embodiment of a gripping head in accordance with the invention.

FIG. 9 shows an example of embodiment of a gripping head in accordance with the invention, designated by the general numerical reference 1.

This gripping head is, generally, intended to grasp a part and deposit it on a target surface.

In the embodiment described, this head is intended to grip a patch made of non- or pre-impregnated fibrous, or non-fibrous, material, and for depositing the patch on a support, during the manufacture of the composite parts.

This gripping head forms an effector intended to be mounted at the end of a carrier of an automatic draping machine such as a robotic arm or controlled by a digital control machine. The head is controlled so that it grasps, by suction, a patch, from a provision device, such as a supply table, a conveyor belt, or a drawer system, deposits the patch on a target surface of a support to be draped, after moving the gripping head under the action of the carrier, and releases or detaches the patch, after applying the patch to the target surface.

The draping machine is programmed in such a way as to automatically perform these various operations and control the motion of the carrier and the gripping head according to a kinematic that depends on the shape of the target surface, in particular when the target surface includes a convexity or an angular surface requiring a movement of the gripping head according to a motion comprising a rotational component about an axis parallel to the surface of the target surface or perpendicular to the normal to this surface.

The support to be draped to which the patches are applied may consist of any type of support and in particular a polymerisation mould, made of metal or polymer material, patches applied beforehand, polymerised or not, or also core materials such as honeycombs, for example made of aluminium or synthetic fibres, or polymer foams.

The patches are for example patches made of a material that is fibrous, dry, that is to say not impregnated with resin, powdery, that is to say having a particle filler, or pre-impregnated with resin.

The gripping head 10 includes a rigid support 11 whereby the head mounts on the carrier and a block 12 of elastically deformable material integral with the support 11, this block being made of porous foam or provided with through channels extending from the support 11 to the active end face of the block 12.

With reference to FIG. 10, the rigid support 11 internally includes a suction chamber 13 internally comprising one or more suction sectors 14a, 14b and 14c and, according to the configuration of the suction chamber 13, one or more suction intakes 15 for selectively placing each suction sector 14a, 14b and 14c in communication with a suction device (not shown) such that the active end face of the gripping head includes gripping zones that are selectively activatable so that a patch can be held locally by the gripping head while being able to be released from it to other gripping zones.

In other words, depending on the vacuum created in the suction sectors, the cells or channels of one or more gripping zones may be subjected to a vacuum to locally grasp a zone of a patch whereas the channels or cells of one or more other gripping zones of the gripper may be subjected to atmospheric pressure or to an overpressure for locally detaching another zone of the patch.

In the embodiment of FIG. 10, the rigid support internally includes three sectors 14a, 14b and 14c. The suction sectors 14a, 14b and 14c are separated by sealed partitions 16 and are each equipped with a distinct suction intake 15 each connected to a suction device for example with the aid of selectively activatable valves.

In the example that can be seen in FIG. 10, the sectorisation of the suction chamber is performed longitudinally. Alternatively, it would also be possible to sectorise the suction chamber laterally, or longitudinally and laterally. As can be seen in this FIG. 10, it is also possible to provide the suction chamber with optional additional pneumatic intakes 17, illustrated in dotted lines, to selectively create an overpressure in each suction sector 14a, 14b and 14c for detaching a zone of a patch.

Alternatively, in the embodiment of FIG. 11, the chamber 13 is sectorised by means of valves 18 controlled, here fictitiously two in number, in such a way as to create in the chamber 13 three suction sectors 14a, 14b and 14c.

In this embodiment, the chamber includes a single suction intake 15 and an optional single overpressure pneumatic intake 17.

This embodiment is particularly adapted to sectorise the suction chamber depending on the size and on the geometry of the patches to be grasped by activating either the central suction sector, or the central suction sector and one of the lateral suction sectors, or also by activating the three suction sectors.

In the embodiment of FIG. 12, which is moreover identical to the embodiment of FIG. 11 in that the suction chamber 13 is sectorised by means of controlled valves 18, each suction sector is provided with a suction intake 15 combined, if applicable, with an optional overpressure intake 17 so as to, on the one hand, during the suction, shape the suction chamber to the shape and to the size of the patch, and to successively and selectively release each zone of the patch depending on the sequence of the phase for applying the patch against the target surface.

Finally, in the embodiment of FIG. 13, the gripping head includes a single suction chamber. The sectorisation of the gripper is carried out by means of valves 19, for example placed on the upstream side of each channel of the gripper, in order to make it possible to selectively close or open each channel.

In FIG. 13, the end channels C1 and C6 are closed, whereas the channels C3 to C5 are open.

Of course, the embodiments described with reference to FIGS. 10 to 13 may possibly be combined.

In the embodiment of FIG. 10, the suction chamber includes a plurality of sectors each served by a suction intake and each associated with a predetermined number of channels or cells.

In the embodiment of FIGS. 11 and 12, the sectorisation of the gripping zones is carried out by sectorising the suction chamber the size of which is adapted by opening and by closing selectively the valves.

Finally, in the embodiment of FIG. 13, the sectorisation of the gripping zones is carried out by acting selectively on the valves equipping the cells or channels of the gripper.

Alternatively, it may be possible for example to envisage that the sectorisation is carried out by acting on suction intakes each acting on a suction sector or by controlling during opening and closing valves to configure the useful inner volume of the suction chamber, in particular to adapt the gripping zone of the gripper to the size of the patch and by acting on the valves equipping the channels of the gripper depending on the movement of the gripper.

In the various embodiments described previously, the control of the valves is carried out by programming, or by servo-control.

The gripping zones of the block 12 of elastically deformable material may be controlled for example by means of one or more elements for measuring pressure, for example sensors 20 (FIG. 10) measuring the pressure and the vacuum in the suction intakes, or depending on the force applied by the gripping head to the patch, by means of force sensors 21 for example distributed at the interface between the block 12 and the support.

Finally, the gripping zones may be selectively active from control data of the gripping head. It may concern data from the program that controls the movement of the head, for example relative to the position of the head or to the configuration of the patch that the head is intended to grasp.

As previously indicated, the gripping head may advantageously be used for gripping and applying patches of various dimensions by activating or by deactivating the gripping zones according to the geometrical features of the patches, only the zones covered by a patch being activated.

1. Gripping head for gripping a part and depositing the part on a target surface, comprising a suction chamber delimiting at least one suction sector and connected to at least one suction intake and a piece of elastically deformable material configured to grip the part under a vacuum effect created in said suction chamber, wherein the piece of elastically deformable material includes selectively activatable gripping zones and in that the gripping head includes means for selectively activating the gripping zones, each suction sector being connected to at least one overpressure intake.

2. The gripping head according to claim 1, wherein the suction chamber comprises a plurality of separate suction sectors each connected to a suction intake, the suction sectors being separated by sealed partitions.

3. The gripping head according to claim 1, wherein the suction chamber includes a plurality of suction sectors separated by valves controlled during opening and closing to selectively place the suction sectors in communication.

4. The gripping head according to claim 1, wherein the piece of elastically deformable material includes a network of channels in communication with the suction chamber.

5. The gripping head according to claim 4, wherein each channel is provided with a valve selectively controlled during opening and closing.

6. The gripping head according to claim 1, wherein the gripping head includes an assembly of at least one element for measuring the application pressure of the gripping head on the target surface to servo-control the application pressure of the gripping head.

7. The gripping head according to claim 1, wherein the means for selectively activating the gripping zones include means for selectively activating the gripping zones depending on the pressure level of the fluid prevailing in the suction sectors.

8. The gripping head according to claim 1, wherein the means for selectively activating the gripping zones include means for selectively activating the suction sectors from control data of the suction head.

9. The gripping head according to claim 1, wherein the part is a patch intended to be applied against a surface to be draped.

10. The gripping head according to claim 1, wherein the means for selectively activating the gripping zones include means for activating the suction sectors depending on the position of the head or on the configuration of the part.

11. A Machine for draping a part to be draped, wherein it includes a gripping head according to claim 1.
